(19) United States
(12) Patent Application Publication
(10) Pub. No.: US 2020/0147760 A1
(43) Pub. Date: May 14, 2020

(54) WORK-HOLDING CLAMP

(71) Applicant: Actuant Corporation, Menomonee Falls, WI (US)

(72) Inventor: James Adam Hefti, Burlington, WI (US)

(21) Appl. No.: 16/679,097

(22) Filed: Nov. 8, 2019

Related U.S. Application Data
(60) Provisional application No. 62/757,430, filed on Nov. 8, 2018.

(51) Int. Cl. B25B 5/06

(52) U.S. Cl. CPC B25B 5/062

(57) ABSTRACT

A swing clamp includes a body having a chamber, a piston supported for movement within the chamber along an axis, and a rod connected to the piston for movement with the piston along the axis. The rod includes a first groove and a second groove. The swing clamp further includes a first guide engaging the first groove at least while the rod moves within a first region along the axis, and a second guide engaging the second groove while the rod moves within a second region along the axis.

### REFERENCE TO RELATED APPLICATION

This application claims the benefit of co-pending, prior-filed U.S. Provisional Patent Application No. 62/757,430, filed Nov. 8, 2018, the entire contents of which are incorporated by reference.

### FIELD

The present disclosure relates to a clamp, and more particularly to a work holding swing clamp.

### SUMMARY

In some aspects, the present disclosure relates to a swing clamp having guide members for guiding movement of a plunger.

In one independent aspect, a swing clamp includes a body having a chamber, a piston supported for movement within the chamber along an axis, and a rod connected to the piston for movement with the piston along the axis. The rod includes a first groove and a second groove. The swing clamp further includes a first guide engaging the first groove at least while the rod moves within a first region along the axis, and a second guide engaging the second groove while the rod moves within a second region along the axis.

In some aspects, movement of the rod in the first region is translational along the axis, and movement of the rod in the second region is translational and rotational about the axis.

In some aspects, the body further includes a first guide aperture and a second guide aperture, the first guide positioned in the first guide aperture and the second guide positioned in the second guide aperture.

In some aspects, the first guide has a first shape and the second guide has a second shape that is different from the first shape.

In some aspects, the rod includes a pair of first grooves and the first guide includes a pair of first guides, each of the first guides engaging an associated one of the first grooves while the rod moves within the first region, each of the first guides including a planar surface and engaging a side of the associated first groove.

In some aspects, the first guide includes a pair of planar surfaces positioned on opposite lateral sides of the first guide, each of the flat surfaces contacting opposite sides of the first groove while the rod moves within the first region along the axis.

In some aspects, the first guide includes a pair of flat surfaces on opposite sides of the pin, the flat surfaces engaging sides of the first groove.

In some aspects, the first groove and the second groove are angularly spaced apart from one another about the axis by at least 90 degrees.

In some aspects, the rod further includes a third groove and a fourth groove, the swing clamp further comprising a third guide engaging the third groove while the rod moves within the first region along the axis and a fourth guide engaging the fourth groove while the rod moves within a second region along the axis.

In some aspects, the first groove and the third groove are angularly spaced apart from one another about the axis by approximately 180 degrees, wherein the second groove and the fourth groove are angularly spaced apart from one another about the axis by approximately 180 degrees.

In some aspects, the first groove includes a linear portion, an arcuate portion, and a transition portion disposed between the linear portion and the arcuate portion.

In some aspects, the linear portion is oriented in a direction parallel to the axis, and the arcuate portion extends at least partially around the axis.

In some aspects, the second groove includes a linear portion, an arcuate portion, and a transition portion disposed between the linear portion and the arcuate portion, wherein engagement of the second guide with the arcuate portion of the second groove causes rotation of the rod about the axis.

In one independent aspect, a swing clamp includes a body having a chamber, and a plunger supported for movement relative to the body along an axis. The plunger is supported for movement relative to the body along an axis, and the plunger is connected to a piston for movement with the piston. The piston is supported for movement within the chamber. The swing clamp further includes a first groove positioned on one of the plunger and an inner surface of the body, a second groove positioned on one of the plunger and the inner surface of the body, a first guide engaging the first groove at least while the plunger moves within a first region along the axis, and a second guide engaging the second groove while the plunger moves within a second region along the axis.

In some aspects, the first groove is positioned on the plunger, and the first guide is supported on the body.

In some aspects, the second groove is positioned on the plunger, and the first guide is supported on the body.

In some aspects, movement of the plunger in the first region is translational along the axis, and movement of the plunger in the second region is translational and rotational about the axis.

In some aspects, the first guide includes a pair of flat surfaces on opposite sides of the pin, the flat surfaces engaging sides of the first groove.

In some aspects, the swing clamp further includes a third groove positioned on one of the plunger and an inner surface of the body, a fourth groove positioned on one of the plunger and an inner surface of the body, a third guide engaging the third groove while the plunger moves within the first region along the axis, and a fourth guide engaging the fourth groove while the plunger moves within a second region along the axis.

In some aspects, the first groove and the third groove are angularly spaced apart from one another about the axis by approximately 180 degrees, wherein the second groove and the fourth groove are angularly spaced apart from one another about the axis by approximately 180 degrees.

In some aspects, the first groove includes a linear portion, an arcuate portion, and a transition portion disposed between the linear portion and the arcuate portion, the linear portion oriented in a direction parallel to the axis, the arcuate portion extending at least partially around the axis.

In some aspects, the second groove includes a linear portion, an arcuate portion, and a transition portion disposed between the linear portion and the arcuate portion, wherein engagement of the second guide with the arcuate portion of the second groove causes rotation of the plunger about the axis.

Other aspects of the disclosure will become apparent by consideration of the detailed description and accompanying drawings.

### BRIEF DESCRIPTION OF THE DRAWINGS

FIG. 1A is a perspective view of a hydraulic swing clamp.

FIG. 1B is a perspective view of a hydraulic swing clamp with a clamp member removed.

FIG. 2 is a perspective view of a body of the hydraulic swing clamp of FIG. 1B.

FIG. 3 is a section view of the hydraulic swing clamp of FIG. 1B, viewed along section line 3-3.

FIG. 4 is a perspective view of a plunger of the hydraulic swing clamp of FIG. 1B.

FIG. 5 is a perspective view of a first guide member for use in the hydraulic swing clamp of FIG. 1B.

FIG. 6 is a perspective view of a second guide member for use in the hydraulic swing clamp of FIG. 1B.

FIG. 7 is a side view of the hydraulic swing clamp of FIG. 1B with the body removed to illustrate the guide members received in an arcuate portion of the guide groove of the plunger.

FIG. 8 is a side view of the hydraulic swing clamp of FIG. 1B with the body removed to illustrate the first guide member received in a transition portion of the guide groove of the plunger.

FIG. 9 is a side view of the hydraulic swing clamp of FIG. 1B with the body removed to illustrate the first guide member received in a linear portion of the guide groove of the plunger.

FIG. 10 is a side view of the hydraulic swing clamp of FIG. 1B with the body removed to illustrate the second guide member received in a linear portion of the guide groove of the plunger.

FIG. 11 is a section view of a hydraulic swing clamp according to another embodiment, viewed along a transverse section of an axis of movement of a plunger.

FIG. 12 is an enlarged view of a portion of the hydraulic swing clamp of FIG. 11.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a swing clamp, such as a hydraulic swing clamp, for applying a clamping force to a workpiece. The swing clamp includes a vertical and rotational component of movement in order to apply a force to the workpiece.

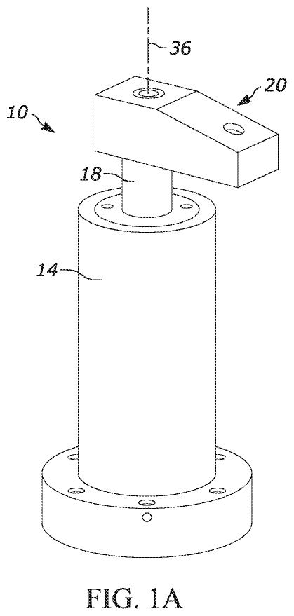

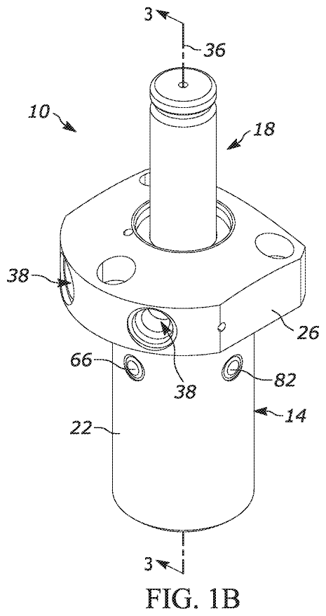

FIG. 1A illustrates a swing clamp (e.g., a hydraulic swing clamp) 10 including a housing or body 14, a rod or plunger 18 that is supported by the body 14, and a clamp member 20 coupled to an end of the plunger 18. The plunger 18 is extendable and retractable relative to the body 14 in a direction parallel to an axis 36. Movement of the plunger 18 drives the clamp member 20 to exert a force against a workpiece (not shown). For example, in some embodiments, retraction of the plunger 18 causes the clamp member 20 to exert a clamping force to secure a workpiece against a support surface (not shown).

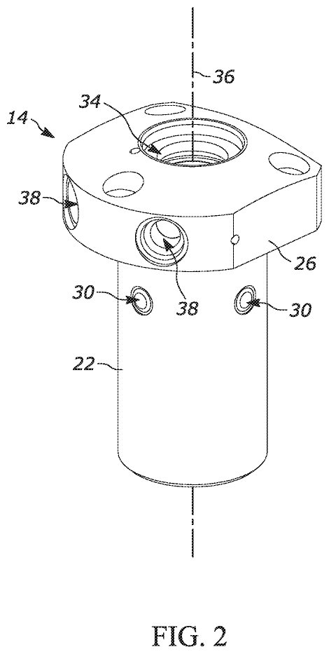

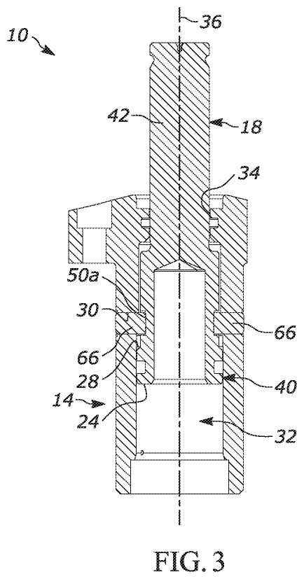

As shown in FIG. 2, the body 14 includes an opening 34 through which a portion of the plunger 18 extends, and the opening 34 is oriented along the axis 36. The body 14 also includes a fluid chamber 32 (FIG. 3) and fluid ports or apertures 38 for conveying pressurized fluid between a source (e.g., a pump—not shown) and the chamber 32.

In the illustrated embodiment, the body 14 also includes guide apertures 30, each of which is oriented in a radial direction relative to the axis 36, and the guide apertures 30 are positioned on a common plane. In some examples, the body 14 includes four guide apertures 30 angularly spaced apart from one another about the axis 36 by 90 degrees; in other embodiments, the body may include fewer or more guide apertures 30, and/or the guide apertures 30 may be oriented in a different configuration. Also, in the illustrated embodiment, the body 14 includes a first or lower portion 22 and a second or upper portion 26, with the lower portion 22 being cylindrical in shape and the upper portion 26 provides a flange that is wider than the lower portion 22. The guide apertures 30 are positioned in the lower portion 22, and the fluid apertures 38 are positioned in the upper portion 26. In other embodiments, the swing clamp may have a different construction; for example, the body may include a flange positioned adjacent a lower end of the body (opposite the end from which the plunger 18 extends), and/or at least a portion of the outer surface of the body can includes threads for threadably securing the swing clamp within a fixture.

As shown in FIG. 3, a piston 40 is positioned in the chamber 32 of the body 14. In the illustrated embodiment, the piston 40 is positioned adjacent an end of the plunger 18 and is formed integrally with the plunger 18. Also, in the illustrated embodiment, the piston 40 includes a first or cap side 24 and a second or rod side 28. The piston 40 is supported for movement within the chamber 32.

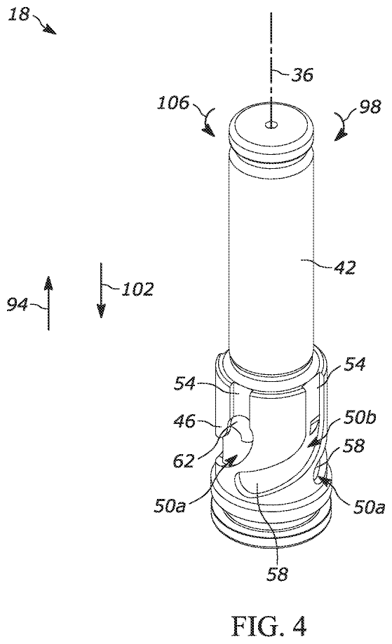

Referring to FIGS. 3 and 4, the plunger 18 includes a first portion or upper body 42 and a second portion or lower body 46. The first portion 42 protrudes from the body 14 (FIG. 1B), and the clamp member 20 is coupled to the first portion 42. In the illustrated embodiment, the second portion 46 is positioned between the first portion 42 and the piston 40. Guide grooves 50 are positioned on the plunger 18; in the illustrated embodiment, and the guide grooves 50 are positioned on the second portion 46 and include a first guide groove 50a and a second guide groove 50b. In the illustrated embodiment, the second portion 46 includes two first guide grooves 50a and two second guide grooves 50b, and the first guide grooves 50a are disposed on opposite sides of the plunger 18 from one another (i.e., 180 degrees apart) and the second guide grooves 50b are disposed on opposite sides of the plunger 18 from one another (i.e., 180 degrees apart). Stated another way, the guide grooves 50a, 50b are spaced apart from one another at 90 degree intervals about the axis 36, and the first guide grooves 50a and second guide grooves 50b alternate with one another. In other embodiments, the guide grooves 50 may be positioned in a different manner.

Each guide groove 50a, 50b includes a first portion or linear portion 54 oriented substantially parallel to the axis 36, and a second portion or arcuate portion 58. The arcuate portion 58 extends at least partially around the axis 36. In the illustrated embodiment, the linear portion 54 is positioned between the arcuate portion 58 and the upper body 42. Also, in the illustrated embodiment each guide groove 50a, 50b is substantially J-shaped, and each arcuate portion 58 extends approximately 90 degrees around the axis 36. In other embodiments, the guide grooves 50a, 50b may be formed in a different manner. Also, in some embodiments, an end of the arcuate portion 58 overlaps with an adjacent guide groove in a direction parallel to the axis 36. A width of the linear portion 54 of the first guide grooves 50a is narrower than a width of the linear portion 54 of the second guide grooves 50b. In the illustrated embodiment, each first guide groove 50a includes a transition portion 62 disposed between the linear portion 54 and the arcuate portion 58. The transition portion 62 can have a substantially circular profile with a diameter or width matching the widest width of the first guide grooves 50a.

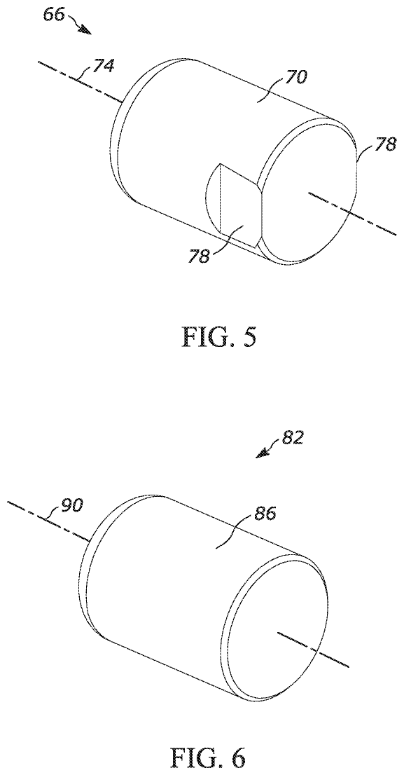

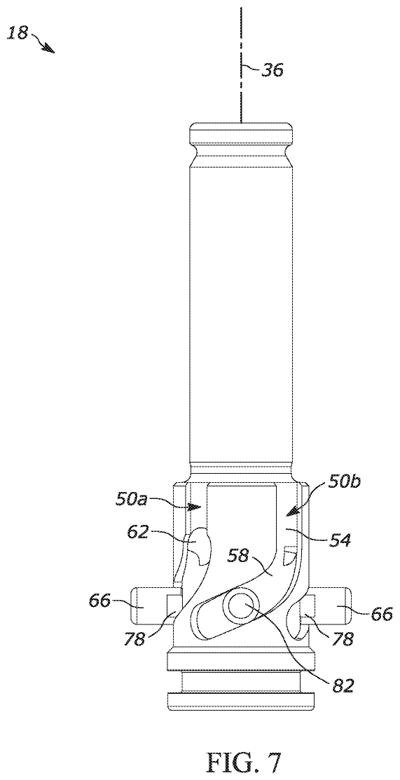

Referring again to FIG. 3, the body 14 supports guide members or pins engaging the guide grooves 50. In particular, first guide members or guide pins 66 engage the first guide grooves 50a, and second guide members or guide pins 82 (FIG. 7) engage the second guide grooves 50b. As shown in FIG. 5, each first guide pin 66 includes a substantially cylindrical body 70 extending along a first pin axis 74. Planar flat surfaces 78 are disposed on opposite sides of the first pin axis 74. The planar surfaces 78 may be ground, forged, or otherwise formed on the guide pin 66. As shown in FIG. 6, each second guide pin 82 includes a substantially cylindrical body 86 extending along a second pin axis 90. The second guide pin 82 lacks the planar surfaces 78, but is substantially the same shape as the first guide pin 66.

As shown in FIG. 7, each of the first guide pins 66 engage a respective one of the first guide grooves 50a, and each of the second guide pines 82 engage a respective one of the second guide grooves 50b. In the illustrated embodiment, each of the guide pins 66, 82 are positioned in a common plane and the axis of each of the pins 66, 82 is oriented in a radial direction relative to the axis 36.

During operation, the plunger 18 can be actuated to extend and retract in order to move the clamp member 20 (FIG. 1A) relative to a workpiece. The engagement of the guide pins 66, 82 in the grooves 50 cause the plunger 18 to move translationally along the axis 36 in a first region, and to move translationally and rotationally about the axis 36 in a second region. In the illustrated embodiment, the pins 66, 82 are positioned at a base end of the arcuate portions 58 of their respective grooves 50a, 50b when the plunger 18 is in an extended position (FIG. 3).

As shown in FIG. 7, as the plunger 18 begins to retract (e.g., move in direction 102—FIG. 4), movement of the plunger 18 is guided by the engagement of pins 66, 82 within the arcuate portions 58 of their respective guide groove 50a, 50b. The plunger 18 moves both translationally relative to the axis 36 and rotationally about the axis 36 while the guide pins 66, 82 engage the arcuate portions 58 of the guide grooves 50a, 50b. The plunger 18 rotates in a first direction 98 (FIG. 4—e.g., clockwise as viewed from the distal end of the plunger 18) as the plunger 18 is retracted. As the plunger 18 moves, the pins 66, 82 remain stationary with respect to the body 14 and remain within their respective guide grooves 50a, 50b in order to guide the movement of the plunger 18.

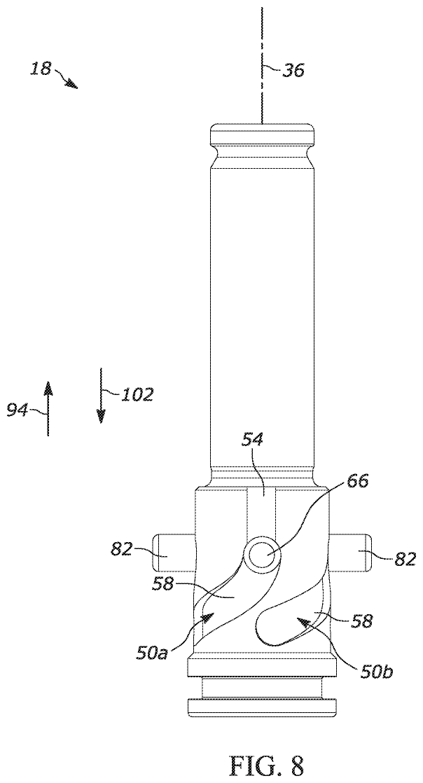

In some embodiments, the first guide pins 66 may not actively engage the arcuate portions 58 of their respective first guide grooves 50a, and only the second guide pins 82 engage the arcuate portions 58 of their respective second guide grooves 50b. That is, the arcuate portions 58 of the first guide grooves 50a may be slightly wider than the first guide pins 66 to avoid contact between the first guide pins 66 and the sides of the arcuate portions 58 of the first guide grooves 50a. Additionally, as shown in FIG. 8, the transition portions 62 can have a width similar to the arcuate portion 58 in order to avoid contact between the transition portions 62 of the first guided grooves 50a and the first guide pins 66.

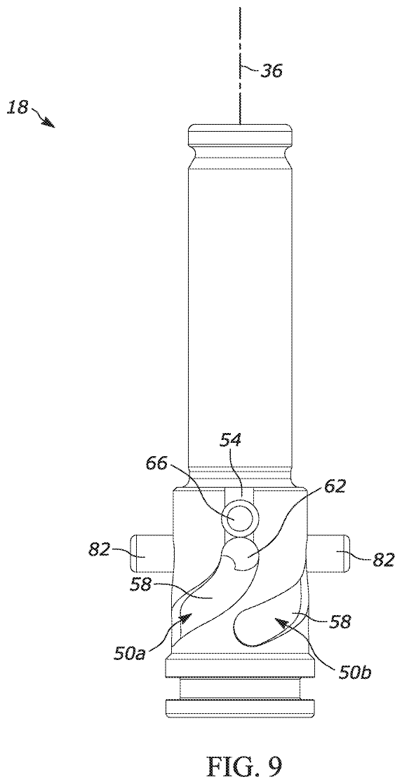

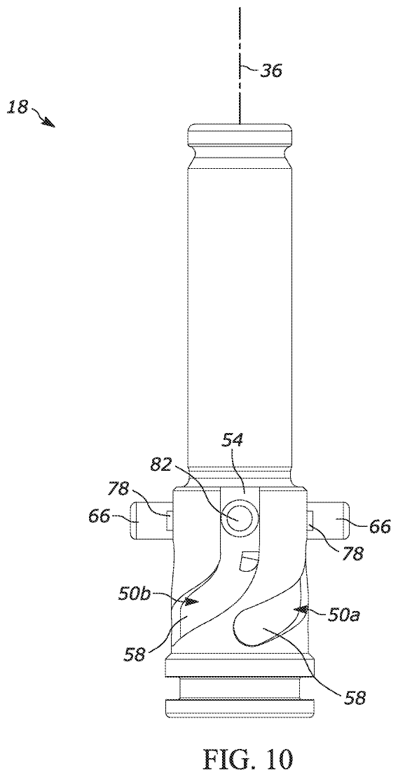

As shown in FIGS. 8 and 9, the transition portion 62 provides a transition between a region of rotational and translational movement of the plunger 18 and a region of only translational movement of the plunger 18. Once the plunger 18 moves in the first direction 102 (e.g., retracts) to the point where the first guide pins 66 have passed the transition portions 62, additional movement of the plunger 18 in the first direction 102 will cause the plunger 18 to move in only a translational manner without accompanying rotation. During movement along the linear portions 54, the planar surfaces 78 of the first guide pins 66 contact the sides of the respective linear portion 54 in order to guide the movement of the plunger 18. The linear portion 54 of each second guide groove 50b is wider than the linear portion 54 of the first guide grooves 50a. The wider linear portions 54 of the second guide grooves 50b provide clearance with the second guide pins 82, thereby minimizing or avoiding contact between the second guide pins 82 and the side walls of the respective linear portions 54 of the second guide grooves 50b during the translation-only region of movement.

In some embodiments, the process may be reversed to extend the plunger 18 and clamp member 20 (FIG. 1A). In the reversed operation, the plunger 18 extends by first moving in a translational manner only in a second linear direction 94 (e.g., upwardly) opposite the first direction, followed by moving in both the second linear direction 94 and a second rotational direction 106 (e.g., counterclockwise—FIG. 4) opposite the first rotational direction 98 until the plunger 18 returns to its initial position (FIG. 1B).

During one stage or region of movement (i.e., while the guide pins 66, 82 are in the arcuate portions 58 of the guide grooves 50), the swing clamp 10 is both translating and rotating the clamp arm 20 (FIG. 1A) to a desired position relative to the work piece. During another or second stage or region of movement (i.e., while the guide pins 66, 82 are in the linear portions 54 of the guide grooves 50), the swing clamp 10 is being translated to either apply force to the workpiece or to release the workpiece. In the illustrated embodiment, one set of the guide members (in some embodiments, this may include all of the guide members) actively engage the guide grooves in the first region, while another set (e.g., a subset) of the guide members actively engage the guide grooves in the second region.

The planar surfaces 78 of the first guide pins 66 facilitate correct positioning of the plunger 18 so that the force is correctly applied. Reducing contact between first guide pins 66 and the guide grooves 50a during the translational and rotational movement of the plunger 18 protects the first guide pins 66 from excessive wear caused by the frictional engagement of these surfaces. Reducing contact with the first guide pins 66 also allows for improved durability of the first guide pins 66, faster application of the clamping force (i.e., solely translational movement), and more accurate repeatability of the cycle than if the first guide pins 66 contacted the guide grooves 50a during the first stage.

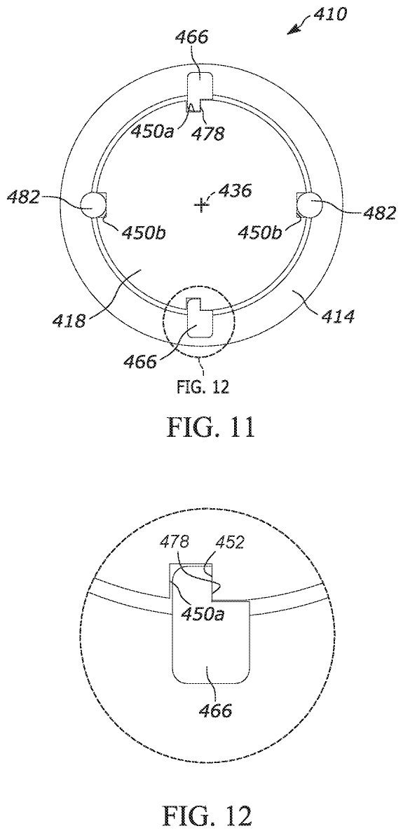

FIGS. 11 and 12 illustrate a swing clamp 410 according to another embodiment. As shown in transverse cross-section and viewed along an axis 436 of a plunger 418, a body 414 supports multiple guide members. In the illustrated embodiment, the body 414 supports a pair of first guide members 466 and a pair of second guide members 482. In the illustrated embodiment, the first guide members 466 are first guide pins and the second guide members 482 are balls. The second guide members 482 may also be formed as elongated pins (similar to the embodiment of FIG. 3 described above). Each first guide member 466 includes a single planar surface 478 formed on one lateral side of the first guide member 466. The planar surface 478 engages a side 452 of a linear portion of a first guide groove 450a. That is, only one surface 478 of each first guide member 466 directly contacts a surface of the associated first guide groove 450a, thereby further reducing wear on the plunger 418 and the guide members 466.

Furthermore, in the illustrated embodiment, the planar surfaces 478 of the first guide pins 466 face in opposite rotational directions about the axis 436. That is, the planar surface 478 of one first guide member 466 faces toward a clockwise rotational direction about the axis 436, while the planar surface 478 of another first guide member 466 faces toward a counter-clockwise rotational direction about the axis 436. The combined engagement of the planar surfaces 478 with the sides of the guide grooves 450a maintains alignment of the plunger 418 relative to the body 414.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

What is claimed is:

1. A swing clamp comprising:
a body having a chamber;
a piston supported for movement within the chamber along an axis;
a rod connected to the piston for movement with the piston along the axis, the rod including a first groove and a second groove;
a first guide engaging the first groove at least while the rod moves within a first region along the axis;
a second guide engaging the second groove while the rod moves within a second region along the axis.

2. The swing clamp of claim 1, wherein movement of the rod in the first region is translational along the axis, and movement of the rod in the second region is translational and rotational about the axis.

3. The swing clamp of claim 1, wherein the body further includes a first guide aperture and a second guide aperture, the first guide positioned in the first guide aperture and the second guide positioned in the second guide aperture.

4. The swing clamp of claim 1, wherein the first guide has a first shape and the second guide has a second shape that is different from the first shape.

5. The swing clamp of claim 1, wherein the rod includes a pair of first grooves and the first guide includes a pair of first guides, each of the first guides engaging an associated one of the first grooves while the rod moves within the first region, each of the first guides including a planar surface and engaging a side of the associated first groove.

6. The swing clamp of claim 1, wherein the first guide includes a pair of planar surfaces positioned on opposite lateral sides of the first guide, each of the flat surfaces contacting opposite sides of the first groove while the rod moves within the first region along the axis.

7. The swing clamp of claim 1, wherein the first groove and the second groove are angularly spaced apart from one another about the axis by at least 90 degrees.

8. The swing clamp of claim 1, wherein the rod further includes a third groove and a fourth groove, the swing clamp further comprising a third guide engaging the third groove while the rod moves within the first region along the axis and a fourth guide engaging the fourth groove while the rod moves within a second region along the axis.

9. The swing clamp of claim 8, wherein the first groove and the third groove are angularly spaced apart from one another about the axis by approximately 180 degrees, wherein the second groove and the fourth groove are angularly spaced apart from one another about the axis by approximately 180 degrees.

10. The swing clamp of claim 1, wherein the first groove includes a linear portion, an arcuate portion, and a transition portion disposed between the linear portion and the arcuate portion.

11. The swing clamp of claim 10, wherein the linear portion is oriented in a direction parallel to the axis, and the arcuate portion extends at least partially around the axis.

12. The swing clamp of claim 1, wherein the second groove includes a linear portion, an arcuate portion, and a transition portion disposed between the linear portion and the arcuate portion, wherein engagement of the second guide with the arcuate portion of the second groove causes rotation of the rod about the axis.

13. A swing clamp comprising:
a body having a chamber;
a plunger supported for movement relative to the body along an axis, the plunger connected to a piston for movement with the piston, the piston supported for movement within the chamber;
a first groove positioned on one of the plunger and an inner surface of the body;
a second groove positioned on one of the plunger and the inner surface of the body;
a first guide engaging the first groove at least while the plunger moves within a first region along the axis; and
a second guide engaging the second groove while the plunger moves within a second region along the axis.

14. The swing clamp of claim 13, wherein the first groove is positioned on the plunger, and the first guide is supported on the body.

15. The swing clamp of claim 13, wherein the second groove is positioned on the plunger, and the first guide is supported on the body.

16. The swing clamp of claim 13, wherein movement of the plunger in the first region is translational along the axis, and movement of the plunger in the second region is translational and rotational about the axis.

17. The swing clamp of claim 13, wherein the first guide includes a pair of flat surfaces on opposite sides of the pin, the flat surfaces engaging sides of the first groove.

18. The swing clamp of claim 13, further comprising:
a third groove positioned on one of the plunger and an inner surface of the body;
a fourth groove positioned on one of the plunger and an inner surface of the body;
a third guide engaging the third groove while the plunger moves within the first region along the axis; and
a fourth guide engaging the fourth groove while the plunger moves within a second region along the axis.

19. The swing clamp of claim 18, wherein the first groove and the third groove are angularly spaced apart from one another about the axis by approximately 180 degrees, wherein the second groove and the fourth groove are angularly spaced apart from one another about the axis by approximately 180 degrees.

20. The swing clamp of claim 13, wherein the first groove includes a linear portion, an arcuate portion, and a transition portion disposed between the linear portion and the arcuate portion, the linear portion oriented in a direction parallel to the axis, the arcuate portion extending at least partially around the axis.

21. The swing clamp of claim 13, wherein the second groove includes a linear portion, an arcuate portion, and a transition portion disposed between the linear portion and the arcuate portion, wherein engagement of the second guide with the arcuate portion of the second groove causes rotation of the plunger about the axis.
